(19) United States
(12) Patent Application Publication
(10) Pub. No.: US 2006/0238598 A1
(43) Pub. Date: Oct. 26, 2006

(54) Laser scan unit assembly and an image forming apparatus having the same

(75) Inventors: Woo-chul Jung, Yongin-si (KR); Se-hyun Lyu, Seoul (KR); Heung-sup Jeong, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/327,488

(22) Filed: Jan. 9, 2006

(30) Foreign Application Priority Data
Apr. 20, 2005 (KR) 2005-32815

(51) Int. Cl. B41J 2/385

(52) U.S. Cl. 347/138

(57) ABSTRACT

A laser scan unit for an image forming apparatus is provided that compensates for an error of the irradiating position of a laser beam on a photoconductive medium, such as the error caused by processing errors or assembling errors of component parts. The laser scan unit includes a frame, a laser scan unit mounted in the frame and projecting a laser beam on a photoconductive medium according to printing data, and a control unit tilting the laser scan unit on the frame to adjust the irradiation position of the laser beam on the photoconductive medium in main scanning and sub scanning directions.

### CROSS-REFERENCE TO RELATED APPLICATIONS

This application claims the benefit under 35 U.S.C. § 119(a) of Korean Patent Application No. 2005-32815, filed Apr. 20, 2005, the entire contents of which are hereby incorporated by reference.

### BACKGROUND OF THE INVENTION

1. Field of the Invention

The present invention relates to an image forming apparatus. More particularly, the present invention relates to a laser scan unit assembly for an image forming apparatus capable of adjusting a position of a laser beam being irradiated on a photoconductive medium.

2. Description of the Related Art

In conventional image forming apparatuses, a photoconductive medium is scanned with a laser beam projected from a laser scan unit to form an electrostatic latent image thereon. The electrostatic latent image is developed to a visible image and the visible image is transferred onto a printing medium. The laser beam needs to be irradiated on a proper position of the photoconductive medium to obtain a desirable image on the printing medium. However, errors generated during processing and assembling of component parts of the laser scan unit may cause an error of the scanning position on the photoconductive medium. Thus, a location and a form of the image transferred on the printing medium may be distorted, and, occasionally, the image may not be formed at all.

Particularly in a special image forming apparatus, such as a laser color printer, the electrostatic latent image is formed on the photoconductive medium by projecting a plurality of laser beams from a plurality of laser scan units. Since the plurality of laser scan units are arranged in parallel at certain intervals, the laser beams projected from the laser scan units are irradiated on the photoconductive medium in a parallel manner to form the electrostatic latent image. However, when the processing errors and assembling errors occur, the plurality of laser beams may not be irradiated on the proper position of the photoconductive medium or may even fail to form the parallel beams. When the plurality of laser beams are not irradiated in a parallel manner on the photoconductive medium, the image quality is degraded because of inconsistency of respective colors.

Accordingly, a need exists for an image forming apparatus having an improved laser scan unit in which the irradiated laser beams are adjustable.

### SUMMARY OF THE INVENTION

Accordingly, an aspect of the present invention is to provide a laser scan unit assembly capable of compensating processing errors and assembling errors to irradiate a laser bean on a correct position of a photoconductive medium, and an image forming apparatus having the same.

A laser scan unit includes a frame, a laser scan unit mounted in the frame that projects a laser beam on a photoconductive medium according to printing data, and a control unit tilting the laser scan unit on the frame to adjust an irradiation position of the laser beam on the photoconductive medium in the main scanning and sub scanning directions.

According to an exemplary embodiment of the present invention, the laser scan unit includes a plurality of output windows allowing the output of a plurality of laser beams. The control unit includes a resilient member disposed between the frame and the laser scan unit. A control screw fastens the frame and the laser scan unit. The laser scan unit has three screw holes for connection with the control screws on a side facing the frame, such that the three screw holes are arranged as the vertexes of a triangle. The resilient member includes a coil spring, and the control screw is inserted in the coil spring. The laser scan unit assembly further includes at least one guide pin formed on the laser scan unit. At least one guide pin hole is formed on the frame for insertion of the guide pin so that the laser scan unit may be provisionally fixed to the frame.

According to another exemplary embodiment of the present invention, the laser scan unit includes three ribs respectively having a connection hole facing the frame. The frame has three screw holes corresponding to the connection holes, and the control screws are engaged with the screw holes by penetrating the connection holes formed on the three ribs.

An image forming apparatus includes a photoconductive medium, a main body supporting the photoconductive medium and having a predetermined frame; and a laser scan unit mounted in the frame to project a laser beam onto the photoconductive medium according to printing data. A control unit tilts the laser scan unit on the frame, thereby adjusting an irradiation position of the laser beam on the photoconductive medium in the main scanning and sub scanning directions. A developing unit is supported by the frame and forms an electrostatic latent image on the photoconductive medium.

Other objects, advantages and salient features of the invention will become apparent from the following detailed description, which, taken in conjunction with the annexed drawings, discloses preferred embodiments of the invention.

### BRIEF DESCRIPTION OF THE DRAWING FIGURES

The above aspects and other features of the present invention will become more apparent by describing in detail exemplary embodiments thereof with reference to the attached drawing figures, wherein;

FIG. 1 is a sectional view schematically illustrating an image forming apparatus according to an exemplary embodiment of the present invention;

FIG. 2 is an exploded, perspective view of components of the image forming apparatus of FIG. 1;

FIGS. 3A and 3B are side elevational views in partial cross section illustrating the operation of a laser scan unit according to an exemplary embodiment of the present invention;

FIGS. 4A and 4B are top plan views in partial cross section illustrating the operation of a laser scan unit according to an exemplary embodiment of the present invention; and

FIG. 5 is an exploded, perspective view schematically illustrating a laser scan unit according to another exemplary embodiment of the present invention.

Throughout the drawings, like reference numerals will be understood to refer to like parts, components and structures.

### DETAILED DESCRIPTION OF EXEMPLARY EMBODIMENTS

Hereinafter, certain exemplary embodiments of the present invention are described in detail with reference to the accompanying drawing figures.

In the following description, the same drawing reference numerals are used for the same elements throughout the drawings. The matters defined in the description, such as a detailed construction thereof, and elements are provided to assist in a comprehensive understanding of the exemplary embodiments of the present invention. Thus, it is apparent that the present invention may be carried out without these defined matters. Also, well-known functions or constructions are omitted to provide a clear and concise specification.

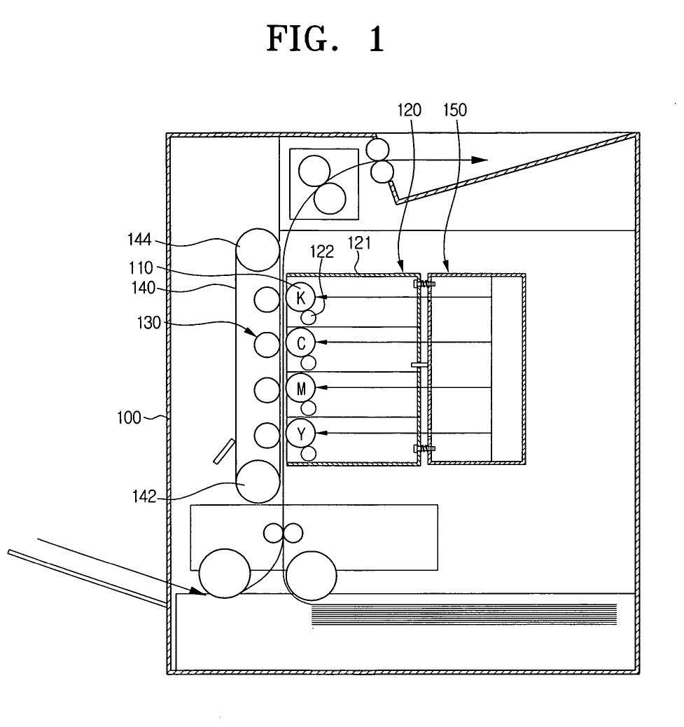

Referring to FIG. 1, an image forming apparatus according to an exemplary embodiment of the present invention includes a main body 100, four photoconductive mediums 110 whereon electrostatic latent images are respectively formed, four developing units 120 developing the electrostatic latent images into visible images, a conveying belt 140 feeding a printing medium to a space between the photoconductive mediums 110 and the transfer units 130, and a laser scan unit assembly 150 forming the electrostatic latent images on the respective photoconductive mediums 110.

The main body 100 constitutes an exterior view of the image forming apparatus and supports the respective component parts.

The photoconductive mediums 110 are divided into four photoconductive mediums for four colors, that is, yellow, magenta, cyan and black. The photoconductive mediums 110 are supplied with yellow, magenta, cyan and black toners from the developing units 120, respectively.

The developing unit 120 includes a developing roller 122 and a feeding roller (not shown) mounted in a frame 121 supported by the main body 100.

The transfer unit 130 transfers an image, which is developed on the photoconductive mediums 110 by the developing units 120, onto the printing medium.

The conveying belt 140 is supported by a driving roller 142 and a backup roller 144 on both sides thereof and feeds the printing medium to a space between the transfer units 130 and the photoconductive mediums 110.

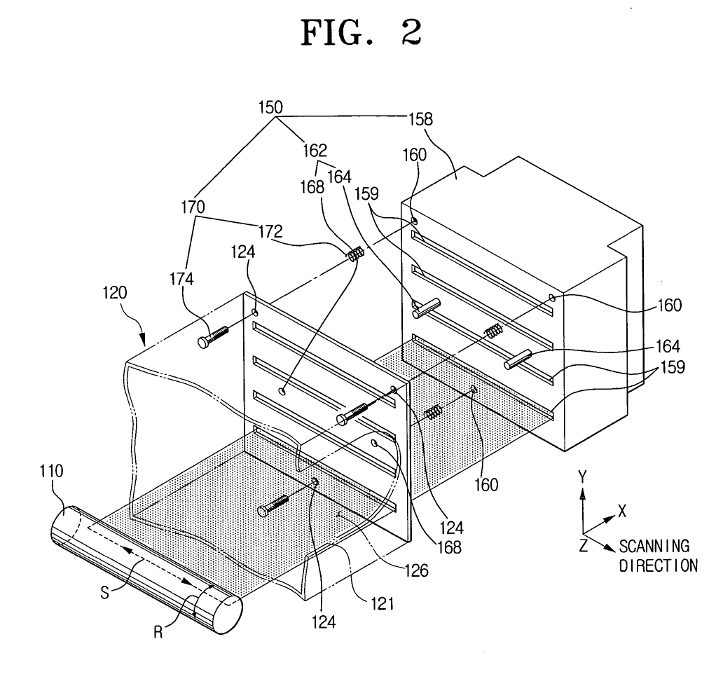

Referring to FIG. 2, the laser scan unit assembly 150 includes a frame 121, a laser scan unit 158, a guide member 162 and a control unit 170.

The frame 121 supports the laser scan unit assembly 150. The frame 121 preferably has three connection holes 124 for engagement with the laser scan unit assembly 150. Additionally, the frame 121 has an operation hole 126 to allow a user's hand to access the connection holes 124.

Alternatively to the present exemplary embodiment, other various members, such as a rib extending from the main body 100, may be employed instead of the frame 121 to support the laser scan unit 158.

The laser scan unit 158 irradiates a laser beam onto the photoconductive mediums 110. To irradiate four laser beams respectively onto the four photoconductive mediums 110, the laser scan unit 158 includes, in one casing, a laser diode (not shown) as a light source, a collimating lens (not shown), a polygonal mirror (not shown), a cylinder lens (not shown), an f·θ lens (not shown) and a reflection mirror (not shown). The front of the laser scan unit 158 has four output windows 159 formed as horizontal slits arranged substantially parallel with one another. The front of the laser scan unit 158 also has three screw holes 160 corresponding to the connection holes 124. Preferably, the screw holes 160 are threaded. Two of the screw holes 160 are disposed on the upper front of the laser scan unit 158 at a predetermined distance, whereas the third screw hole 160 is disposed on the lower center of the front of the laser scan unit 158.

The guide member 162 provisionally fixes the laser scan unit 158 on the frame 121. Therefore, the guide member 162 includes a guide pin 164 and a guide pin hole 168.

Two guide pins 164 transversely protrude from a central, front portion of the laser scan unit 158 at a predetermined distance in a direction in which the laser beam irradiates.

A pair of the guide holes 168 are formed in the frame 121 corresponding to the guide pins 164 and are adapted to receive the guide pins 164. The guide pin hole 168 has a larger diameter than the guide pin 164 so that the guide pin 164 penetrates and moves along the guide pin hole 168.

The control unit 170 tilts the laser scan unit 158 on the frame 121, thereby adjusting the laser beam irradiating direction. The control unit 170 includes a resilient member 172 and a control screw 174.

The resilient member 172 is disposed between the laser scan unit 158 and the frame 121 corresponding to the connection holes 124 and the screw holes 160. Preferably, the resilient member 172 is a coil spring in this exemplary embodiment; however, other materials, such as rubber, may be used as well.

The control screw 174 engages the screw hole 160 by penetrating the connection hole 124 and the resilient member 172. Thus, since the three connection holes 124, the screw holes 160, the resilient members 172 and the control screws 174 are not linearly arranged, in other words, because the three screw holes 160 are disposed as vertexes of a triangle, the laser scan unit 158 may be tilted bi-directionally.

Hereinafter, a method of constructing the laser scan unit assembly 150 is described. First, the laser scan unit 158 is provisionally fixed to the frame 121 by inserting the guide pins 164 in the guide pin holes 168. Then, the resilient members 172 are disposed between the laser scan unit 158 and the frame 121, and the control screws 174 are inserted in the connection holes 124 and the resilient members 172 through the operation holes 125 and finally engaged with the screw holes 160.

Next, the laser scan unit 158 is tilted on the frame 121, thereby adjusting the laser beam irradiation direction. Hereinafter, a method of tilting the laser scan unit 158 is described.

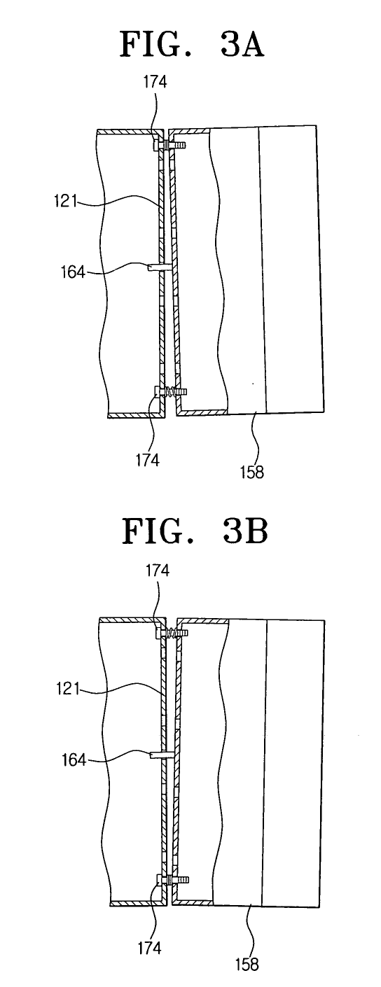

Referring to FIGS. 3A and 3B, the laser scan unit 158 may be positioned as shown in FIG. 3A by fastening the two control screws 174 engaged with the upper front of the laser scan unit 158 more tightly than the third control screw 174 engaged with the lower front of the laser scan unit 158. Alternatively, to position the laser scan unit 158 as shown in FIG. 3B, the two control screws 174 engaged on the upper front of the laser scan unit 158 are fastened less tightly than the third control screw 174 engaged on the lower front of the laser scan unit 158. By tilting the laser scan unit 158 on the frame 121 as shown in FIGS. 3A and 3B, the laser scan unit 158 is pivotable on a Z-axis (FIG. 2), thereby enabling control of the irradiation position of the laser beams projected from the laser scan unit 158 and irradiated on the photoconductive medium 110 with respect to a sub scanning direction R (FIG. 2).

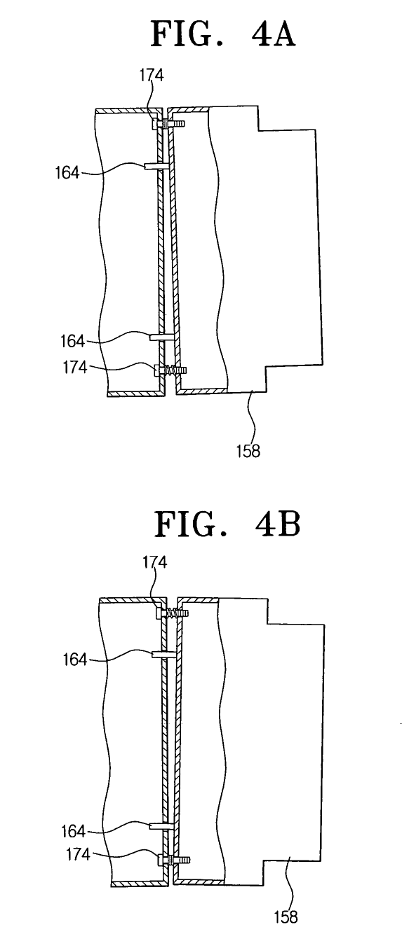

Referring to FIGS. 4A and 4B, the laser scan unit 158 is pivotable on a Y-axis (FIG. 2) by adjusting tightness of the control screw 174 fastened on the left and the right of the upper front of the laser scan unit 158. Pivoting the laser scan unit 158 on the Y-axis adjusts the irradiation position of the laser beam with respect to a main scanning direction S (FIG. 2).

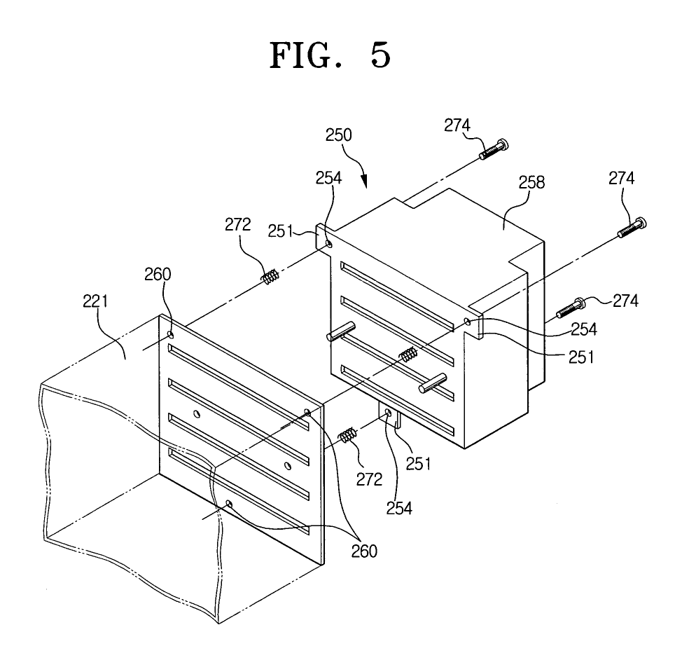

Referring to FIG. 5, which shows a laser scan unit assembly 250 according to another exemplary embodiment of the present invention, three ribs 251 are formed on the front of a laser scan unit 258 facing a frame 221. Two of the ribs 251 are disposed on the upper front of the laser scan unit 258 while the third rib 251 is disposed on the lower center of the front of the laser scan unit 258. Each of the respective ribs 251 has a connection hole 254. The frame 221 has three screw holes 260 corresponding to the connection holes 254. By the above structure, the control screws 274 are engaged with the screw holes 260 formed on the frame 221 by penetrating the connection holes 254 and resilient members 272. According to this exemplary embodiment, access to the control screw 174 is more convenient than that in the previous exemplary embodiment wherein the user manipulates the control screw 174 through the operation hole 126.

Although the laser scan units 158 and 258 projecting four laser beams are tilted with respect to the frames 121 and 221 in the exemplary embodiments of the present invention, four laser scan units may be separately connected to a frame and tilted on the frame. In addition to adjusting the irradiation position of the laser beam, the parallelism of the laser beams may also be adjusted.

As described above, according to the exemplary embodiment of the present invention, an error of the irradiation position of the laser beam, which is caused by the processing error or the assembling error of the parts of the image forming apparatus, may be compensated, thereby improving the image quality.

Additionally, parallelism of the laser beams may be adjusted by controlling the respective laser scan units.

Moreover, since a housing of the developing unit may serve as the frame without requiring a dedicated frame for mounting the laser scan unit, the number of parts is reduced, thereby realizing a smaller and slimmer image forming apparatus.

While the invention has been shown and described with reference to certain embodiments thereof, it will be understood by those skilled in the art that various changes in form and details may be made therein without departing from the spirit and scope of the invention as defined by the appended claims.

What is claimed is:

1. A laser scan unit assembly, comprising:
a frame;
a laser scan unit mounted in the frame and adapted to project a laser beam on a photoconductive medium according to printing data; and
a control unit adapted to tilt the laser scan unit on the frame to adjust an irradiation position of the laser beam on the photoconductive medium in main scanning and sub scanning directions.

2. The laser scan unit assembly of claim 1, wherein
the laser scan unit includes a plurality of output windows allowing output of a plurality of laser beams.

3. The laser scan unit assembly of claim 2, wherein the control unit includes
a resilient member disposed between the frame and the laser scan unit; and
a control screw connecting the frame and the laser scan unit.

4. The laser scan unit assembly of claim 3, wherein
the laser scan unit has three screw holes adapted to receive the control screws on a side facing the frame, such that the three screw holes are arranged as vertexes forming a triangle.

5. The laser scan unit assembly of claim 3, wherein
the resilient member includes a coil spring, and the control screw is inserted in the coil spring.

6. The laser scan unit assembly of claim 1, wherein
the laser scan unit includes three ribs, each of which has a connection hole facing the frame,
the frame has three screw holes corresponding to the connection holes, and
the control screws engage the screw holes by penetrating the connection holes formed in the three ribs.

7. The laser scan unit assembly of claim 1, wherein
a guide member fixes the laser scan unit to the frame.

8. The laser scan unit assembly of claim 7, wherein the guide member includes
at least one guide pin formed on the laser scan unit; and
at least one guide pin hole formed in the frame to receive the guide pin.

9. An image forming apparatus, comprising:
a photoconductive medium;
a main body supporting the photoconductive medium and having a frame;
a laser scan unit mounted in the frame adapted to project a laser beam onto the photoconductive medium according to printing data;
a control unit adapted to tilt the laser scan unit on the frame to adjust an irradiation position of the laser beam on the photoconductive medium in main scanning and sub scanning directions; and
a developing unit supported by the frame and forming an electrostatic latent image on the photoconductive medium.

10. The image forming apparatus of claim 9, wherein
the laser scan unit includes a plurality of output windows allowing output of a plurality of laser beams.

11. The image forming apparatus of claim 10, wherein the control unit includes
a resilient member disposed between the frame and the laser scan unit; and
a control screw fastens the frame and the laser scan unit.

12. The image forming apparatus of claim 11, wherein
the laser scan unit has three screw holes adapted to receive the control screws on a side facing the frame, such that the three screw holes are arranged as vertexes forming a triangle.

13. The image forming apparatus of claim 11, wherein
the resilient member includes a coil spring, and the control screw is inserted in the coil spring.

14. The image forming apparatus of claim 11, wherein
the laser scan unit includes three ribs, each of which has a connection hole facing the frame,
the frame has three screw holes corresponding to the connection holes, and
the control screws engage the screw holes by penetrating the connection holes formed in the three ribs.

15. The image forming apparatus of claim 9, wherein
a guide member fixes the laser scan unit to the frame.

16. A method of adjusting a laser scan unit of an image forming apparatus, comprising the steps of
mounting the laser scan unit to a frame of the image forming apparatus;
tilting the laser scan unit on the frame to adjust an irradiation position of the laser beam on a photoconductive medium in main scanning and sub scanning directions.

17. A method of adjusting a laser scan unit of an image forming apparatus according to claim 16, wherein
mounting the laser scan unit to the frame further comprises engaging three control screws between the frame and the laser scan unit and disposing a resilient member between the laser scan unit and the frame through which each control screw passes.

18. A method of adjusting a laser scan unit of an image forming apparatus according to claim 17, further comprising
disposing two control screws proximal an upper edge of the laser scan unit and the frame and disposing a third control screw proximal a lower edge of the laser scan unit and the frame.

19. A method of adjusting a laser scan unit of an image forming apparatus according to claim 18, wherein
the upper two control screws are tightened to a different degree than the lower third control screw to adjust laser beams irradiated by the laser scan unit in the sub scanning direction.

20. A method of adjusting a laser scan unit of an image forming apparatus according to claim 19, wherein
the upper two control screws are tightened to a different degree with respect to each other to adjust the laser beams irradiated by the laser scan unit in the main scanning direction.
